(19) United States
(12) Patent Application Publication
(10) Pub. No.: US 2023/0023255 A1
(43) Pub. Date: Jan. 26, 2023

(54) CONTROLLED INGESTION OF MAP UPDATE DATA

(71) Applicant: HERE Global B.V., Eindhoven (NL)

(72) Inventors: Hemanshu Belani, Mumbai (IN); Ninad Raut, Mumbai (IN)

(73) Assignee: HERE Global B.V., Eindhoven (NL)

(21) Appl. No.: 17/383,896

(22) Filed: Jul. 23, 2021

(51) Int. Cl. G01C 21/00

(52) U.S. Cl. CPC G01C 21/3807; G01C 21/387

(57) ABSTRACT

An apparatus receives a plurality of instances of map update data during a time window. Each instance is associated with a respective geographic region of a plurality of defined geographic regions. The apparatus determines, for the time window, region rankings for the plurality of defined geographic regions. A region ranking is determined based on a volume measure, a measure of map update activity, a measure of inaccurate activity, a general priority weight, and/or an interest density corresponding to the respective geographic region. The apparatus determines, for the time window, respective ranking ranges for a plurality of data buckets and assigns respective instance rankings to the instances of map update data. The instances are assigned to data buckets based on the instance rankings and ranking ranges. The apparatus ingests the instances based on the respective data buckets to cause a digital map maintained by the apparatus to be updated.

### TECHNOLOGICAL FIELD

An example embodiment relates to controlling ingestion of map update data for generating and/or updating a digital map. An example embodiment relates to controlling ingestion of map update data in a crowd-sourced map generation and/or update process.

### BACKGROUND

In conventional crowd-sourced map generation and/or update processes, a plurality of instances of map update data are received by a server and processed based on the order in which the instances of map update data are received. In a crowd-sourced environment, the receiver of the instances of map update data does not control over the amount of map update data being received ingestion at a given time and the compute/integration power of integration system is a finite resource. Thus, when large amounts of map update data are received in close proximity, the important updates to the map may not be timely implemented.

### BRIEF SUMMARY

Various embodiments provide methods, apparatus, systems, and computer program products for controlling ingestion of instances of map update data for use in generating and/or updating a digital map. In various embodiments, a probe device captures sensor data using one or more sensors thereof and, based thereon, generates instances of map update data. The probe device provides and/or transmits the instances of map update data such that the instances of map update data are received by an update apparatus. Each instance of map update data comprises (a) an instance of location data indicating a location corresponding to the map update data and/or (b) a geographic region identifier indicating and/or identifying a geographic region corresponding the location corresponding to the map update data.

The update apparatus receives the instances of map update data during a time window. Based on one or more and/or a combination of measures, one or more of which corresponds to the time window, the update apparatus determines a respective region ranking corresponding to each geographic region of a plurality of defined geographic regions. The update apparatus determines respective ranking ranges for each of a plurality of data buckets, bins, and/or buffers (e.g., a region of a physical memory storage used to temporarily store data until the data is ingested and/or processed via an ingestion engine). The update apparatus determines respective instance rankings for each received instance of map update data based at least in part on the region ranking corresponding to the geographic region indicated by the respective instance of location data and/or geographic region identifier. The respective instances of map data are then stored to respective data buckets, bins, and/or buffers (referred to as data buckets herein) based on the respective instance ranking and the ranking ranges corresponding to the data buckets. Each data bucket is then ingested by computational resources dedicated to the respective data bucket. For example, a first set of processing elements are configured to ingest instances of map update data from a first data bucket and a second set of processing elements are configured to ingest instances of map update data from a second data bucket.

In various embodiments, the update apparatus generates batches of instances of map update data within each data bucket. For example, by clustering the instances of map update data stored to a particular data bucket based on the respective instances of location data, for example, the instances of map update data within particular data bucket may be organized into batches. The batches may then be ingested and/or processed (e.g., via an ingestion engine) using a batch processing technique. In various embodiments, such batch processing of location-clustered batches reduces the computational resources needed to process the batch of instances of map update data due to, for example, the need to access less map data from the geographical database storing the digital map to process each batch (e.g., since the instances of map update data within the batch are likely to correspond to overlapping map data).

When instances of map update data are ingested, the instances of map update data may be analyzed to determine whether the respective instances are likely to be inaccurate activity (e.g., provided by a bad faith actor, provided by a probe device having a malfunctioning sensor and/or experiencing inaccurate positioning, and/or the like), used to generate and/or update a digital map, and/or the like. As the instances of map update data are ingested (e.g., as a result thereof), a digital map is generated and/or updated. In various embodiments, the update apparatus provides at least a portion of the digital map and/or map updates to one or more servers, mobile devices, user computing devices, Cloud-based services, and/or the like. The servers, mobile devices, user computing devices, Cloud-based services, and/or the like may use at least a portion the digital map (and/or a digital map that is updated based on the map update(s)) to perform one or more positioning and/or navigation-related functions. The navigation-related functions can correspond to vehicle navigation or other types of navigation. Some non-limiting examples of positioning and/or navigation-related functions include determining a position estimate, providing a route (e.g., via a user interface), localization, route determination, lane level route determination, operating a vehicle along a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, and/or the like.

By controlling which data buckets instances of map update data are assigned to for ingestion and/or processing, instances of map update data with a higher priority and/or corresponding to geographic regions and/or a geographic area within a geographic region where the timeliness and/or freshness of the updated digital map is a priority can be assigned to data buckets having higher processing rates (e.g., more computational resources and/or less volume of instances of map update data for processing) while continuing to process lower priority instances of map update data so as to not create a backlog of instances of map update information for processing.

As should be understood, a first plurality of instances of map update data are received during a first time window. During a second time window that is immediately preceded by the first time window, a second plurality of instances of map update data are received. Thus, in various embodiments, the various processes described herein are executed in a continuous manner and/or iterated over the various time windows. For example, the one or more measures and/or combinations thereof used to determine region rankings may be updated in a continuous and/or (near) real-time manner during the execution of the ingestion controlling process.

In an example embodiment, an update apparatus receives a plurality of instances of map update data during a time window. Each instance of map update data of the plurality of instances of map update data associated with a respective geographic region of a plurality of defined geographic regions. The update apparatus determines, for the time window, respective region rankings for the plurality of defined geographic regions. A region ranking for a particular geographical region is determined based at least in part on one or more of (a) a number of the plurality of instances of map update data associated with a respective geographic region of the plurality of defined geographic regions, (b) a measure of map update activity corresponding to the respective geographic region, (c) a measure of inaccurate activity corresponding to the respective geographic region, (d) a weight assigned to the respective geographic region, or (e) an interest density corresponding to the respective geographic region. The update apparatus determines, for the time window, respective ranking ranges for a plurality of data buckets. The update apparatus assigns a respective instance ranking to instances of map update data of the plurality of instances of map update data based at least in part on the respective region ranking determined for the respective geographic region. The update apparatus assigns instances of map update data to respective data buckets based on the respective instance rankings of the instances of map update data and the respective ranking ranges of the respective data buckets. The update apparatus ingests the respective instances of map update data based on the respective data buckets to cause a digital map maintained by the update apparatus to be updated.

According to an aspect of the present disclosure, a method for ingesting instances of map update data by an update apparatus configured to maintain (e.g., store, generate, and/or update) a digital map. In an example embodiment, the method comprises receiving, by the update apparatus, a plurality of instances of map update data during a time window. Each instance of map update data of the plurality of instances of map update data associated with a respective geographic region of a plurality of defined geographic regions. The method further comprises determining, by the update apparatus and for the time window, respective region rankings for the plurality of defined geographic regions. A region ranking for a particular geographic region determined based at least in part on one or more of (a) a number of the plurality of instances of map update data associated with a respective geographic region of the plurality of defined geographic regions, (b) a measure of map update activity corresponding to the respective geographic region, (c) a measure of inaccurate activity corresponding to the respective geographic region, (d) a weight assigned to the respective geographic region, or (e) an interest density corresponding to the respective geographic region. The method further comprises determining, by the update apparatus and for the time window, respective ranking ranges for a plurality of data buckets; and assigning, by the update apparatus, a respective instance ranking to instances of map update data of the plurality of instances of map update data based at least in part on the respective geographic region associated with the respective instance of map update data and the respective region ranking determined for the respective geographic region. The method further comprises assigning, by the update apparatus, instances of map update data to respective data buckets based on the respective instance rankings of the instances of map update data and the respective ranking ranges of the respective data buckets; and ingesting, by the update apparatus, the respective instances of map update data based on the respective data buckets to cause a digital map maintained by the update apparatus to be updated.

In an example embodiment, the respective instances of map data assigned to a particular data bucket are ingested using computational resources dedicated to the particular data bucket.

In an example embodiment, a first group of processing elements are configured to ingest respective instances of map data assigned to a first bucket of the plurality of data buckets and a second group of processing elements are configured to ingest respective instances of map data assigned to a second bucket of the plurality of buckets.

In an example embodiment, the region ranking for the particular geographic region is determined based at least in part on an error function.

In an example embodiment, the respective instance ranking for a particular instance of map update data is determined based at least in part on at least one of (a) a geographic area associated with the particular instance of update data, the geographic area being within the geographic region of the plurality of defined geographic regions associated with the particular instance of map update data, (b) an entity that generated the particular instance of map update data, or (c) a map element type to which the particular instance of map update data corresponds.

In an example embodiment, the method further comprises during the ingestion of at least one instance of map update data, identifying a contentious map update; providing respective update confirmation requests to one or more probe devices corresponding to the contentious map update; receiving respective update confirmations corresponding to the contentious map update; and processing the respective update confirmations.

In an example embodiment, the respective update confirmations are assigned respective instance rankings and assigned to respective data buckets based thereon.

According to another aspect of the present disclosure, an apparatus is provided. In an example embodiment, the apparatus comprises at least one processor and at least one memory storing computer program instructions. The at least one memory and the computer program instructions are configured to, with the at least one processor, cause the apparatus to at least receive a plurality of instances of map update data during a time window. Each instance of map update data of the plurality of instances of map update data associated with a respective geographic region of a plurality of defined geographic regions. The at least one memory and the computer program instructions are further configured to, with the at least one processor, cause the apparatus to at least determine, for the time window, respective region rankings for the plurality of defined geographic regions. A region ranking for a particular geographic region determined based at least in part on one or more of (a) a number of the plurality of instances of map update data associated with a respective geographic region of the plurality of defined geographic regions, (b) a measure of map update activity corresponding to the respective geographic region, (c) a measure of inaccurate activity corresponding to the respective geographic region, (d) a weight assigned to the respective geographic region, or (e) an interest density corresponding to the respective geographic region. The at least one memory and the computer program instructions are further configured to, with the at least one processor, cause the apparatus to at least determine, for the time window, respective ranking ranges for a plurality of data buckets; and assign a respective instance ranking to instances of map update data of the plurality of instances of map update data based at least in part on the respective geographic region associated with the respective instance of map update data and the respective region ranking determined for the respective geographic region. The at least one memory and the computer program instructions are further configured to, with the at least one processor, cause the apparatus to at least assign instances of map update data to respective data buckets based on the respective instance rankings of the instances of map update data and the respective ranking ranges of the respective data buckets; and ingest the respective instances of map update data based on the respective data buckets to cause a digital map maintained by the apparatus to be updated.

In an example embodiment, the respective instances of map data assigned to a particular data bucket are ingested using computational resources dedicated to the particular data bucket.

In an example embodiment, a first group of processing elements are configured to ingest respective instances of map data assigned to a first bucket of the plurality of data buckets and a second group of processing elements are configured to ingest respective instances of map data assigned to a second bucket of the plurality of buckets.

In an example embodiment, the region ranking for the particular geographic region is determined based at least in part on an error function.

In an example embodiment, the respective instance ranking for a particular instance of map update data is determined based at least in part on at least one of (a) a geographic area associated with the particular instance of update data, the geographic area being within the geographic region of the plurality of defined geographic regions associated with the particular instance of map update data, (b) an entity that generated the particular instance of map update data, or (c) a map element type to which the particular instance of map update data corresponds.

In an example embodiment, the at least one memory and the computer program instructions are further configured to, with the at least one processor, cause the apparatus to at least during the ingestion of at least one instance of map update data, identify a contentious map update; provide respective update confirmation requests to one or more probe devices corresponding to the contentious map update; receive respective update confirmations corresponding to the contentious map update; and process the respective update confirmations.

In an example embodiment, the respective update confirmations are assigned respective instance rankings and assigned to respective data buckets based thereon.

In still another aspect of the present disclosure, a computer program product is provided. In an example embodiment, the computer program product comprises at least one non-transitory computer-readable storage medium having computer-readable program code and/or instructions portions stored therein. The computer-readable program code and/or instructions portions comprise executable portions configured, when executed by a processor of an apparatus, to cause the apparatus to receive a plurality of instances of map update data during a time window. Each instance of map update data of the plurality of instances of map update data associated with a respective geographic region of a plurality of defined geographic regions. The computer-readable program code and/or instructions portions comprise executable portions further configured, when executed by a processor of an apparatus, to cause the apparatus to determine, for the time window, respective region rankings for the plurality of defined geographic regions. A region ranking for a particular geographic region determined based at least in part on one or more of (a) a number of the plurality of instances of map update data associated with a respective geographic region of the plurality of defined geographic regions, (b) a measure of map update activity corresponding to the respective geographic region, (c) a measure of inaccurate activity corresponding to the respective geographic region, (d) a weight assigned to the respective geographic region, or (e) an interest density corresponding to the respective geographic region. The computer-readable program code and/or instructions portions comprise executable portions further configured, when executed by a processor of an apparatus, to cause the apparatus to determine, for the time window, respective ranking ranges for a plurality of data buckets; and assign a respective instance ranking to instances of map update data of the plurality of instances of map update data based at least in part on the respective geographic region associated with the respective instance of map update data and the respective region ranking determined for the respective geographic region. The computer-readable program code and/or instructions portions comprise executable portions further configured, when executed by a processor of an apparatus, to cause the apparatus to assign instances of map update data to respective data buckets based on the respective instance rankings of the instances of map update data and the respective ranking ranges of the respective data buckets; and ingest the respective instances of map update data based on the respective data buckets to cause a digital map maintained by the apparatus to be updated.

In an example embodiment, the respective instances of map data assigned to a particular data bucket are ingested using computational resources dedicated to the particular data bucket.

In an example embodiment, a first group of processing elements are configured to ingest respective instances of map data assigned to a first bucket of the plurality of data buckets and a second group of processing elements are configured to ingest respective instances of map data assigned to a second bucket of the plurality of buckets.

In an example embodiment, the region ranking for the particular geographic region is determined based at least in part on an error function.

In an example embodiment, the respective instance ranking for a particular instance of map update data is determined based at least in part on at least one of (a) a geographic area associated with the particular instance of update data, the geographic area being within the geographic region of the plurality of defined geographic regions associated with the particular instance of map update data, (b) an entity that generated the particular instance of map update data, or (c) a map element type to which the particular instance of map update data corresponds.

In an example embodiment, The computer-readable program code and/or instructions portions comprise executable portions further configured, when executed by a processor of an apparatus, to cause the apparatus to during the ingestion of at least one instance of map update data, identify a contentious map update; provide respective update confirmation requests to one or more probe devices corresponding to the contentious map update; receive respective update confirmations corresponding to the contentious map update; and process the respective update confirmations.

In an example embodiment, the respective update confirmations are assigned respective instance rankings and assigned to respective data buckets based thereon.

According to yet another aspect, an apparatus is provided. In an example embodiment, the apparatus comprises means for receiving a plurality of instances of map update data during a time window. Each instance of map update data of the plurality of instances of map update data associated with a respective geographic region of a plurality of defined geographic regions. The apparatus comprises means for determining, for the time window, respective region rankings for the plurality of defined geographic regions. A region ranking for a particular geographic region determined based at least in part on one or more of (a) a number of the plurality of instances of map update data associated with a respective geographic region of the plurality of defined geographic regions, (b) a measure of map update activity corresponding to the respective geographic region, (c) a measure of inaccurate activity corresponding to the respective geographic region, (d) a weight assigned to the respective geographic region, or (e) an interest density corresponding to the respective geographic region. The apparatus comprises means for determining, for the time window, respective ranking ranges for a plurality of data buckets. The apparatus comprises means for assigning a respective instance ranking to instances of map update data of the plurality of instances of map update data based at least in part on the respective geographic region associated with the respective instance of map update data and the respective region ranking determined for the respective geographic region. The apparatus comprises means for assigning instances of map update data to respective data buckets based on the respective instance rankings of the instances of map update data and the respective ranking ranges of the respective data buckets. The apparatus comprises means for ingesting the respective instances of map update data based on the respective data buckets to cause a digital map maintained by the apparatus to be updated.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example system of one embodiment of the present disclosure;

FIG. 2A is a block diagram of an update apparatus that may be specifically configured in accordance with an example embodiment;

FIG. 2B is a block diagram of a probe device that may be specifically configured in accordance with an example embodiment;

FIG. 3 is a schematic diagram illustrating portions of a controlled ingestion program, in accordance with an example embodiment; and

FIG. 4 is a flowchart illustrating operations performed, such as by the update apparatus of FIG. 2A, in accordance with an example embodiment.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms may be used interchangeably to refer to data capable of being transmitted, received and/or stored in accordance with embodiments of the present invention. As used herein, the terms “substantially” and “approximately” refer to values and/or tolerances that are within manufacturing and/or engineering guidelines and/or limits. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware.

### General Overview

Various embodiments provide methods, apparatus, systems, and computer program products for controlling ingestion of instances of map update data for use in generating and/or updating a digital map. In various embodiments, a probe device captures sensor data using one or more sensors thereof and, based thereon, generates instances of map update data. The probe device provides and/or transmits the instances of map update data such that the instances of map update data are received by an update apparatus. Each instance of map update data comprises (a) an instance of location data indicating a location corresponding to the map update data and/or (b) a geographic region identifier indicating and/or identifying a geographic region corresponding the location corresponding to the map update data. In various embodiments, each instance of map update data comprises one or more elements of map data. In an example the map data is provided as a maplet, as disclosed in U.S. application Ser. No. 16/352,225, filed Mar. 13, 2019 and published as U.S. Publication No. 2020/0292323, published Sep. 17, 2020, the content of which is incorporated herein in its entirety by reference. In various embodiments, the map data corresponds to sensor data and/or observation of one or more features, road side barriers, traffic signals, signs, road surface markings, pole-like objects (e.g., telephone poles, sign posts, etc.), pavement and/or driving surface edge, lane markings, construction markings, buildings, parking areas, points of interest (POIs), probe device trajectory, network access point and/or radio node, and/or the like.

The update apparatus receives the instances of map update data during a time window. Based on one or more and/or a combination of measures, one or more of which corresponds to the time window, the update apparatus determines a respective region ranking corresponding to each geographic region of a plurality of defined geographic regions. In various embodiments, the region rankings are determined based on one or more and/or a combination of one or more of (a) a number of the plurality of instances of map update data associated with a respective geographic region of the plurality of defined geographic regions received during a particular time period corresponding to the time window (e.g., during the preceding time window, during the portion of the time window that has passed, in a sliding time period, and/or the like), (b) a measure of map update activity corresponding to the respective geographic region during the particular time period corresponding to the time window, (c) a measure of inaccurate activity corresponding to the respective geographic region during the particular time period corresponding to the time window, (d) a weight assigned to the respective geographic region; or (e) an interest density corresponding to the respective geographic region, and/or the like.

The update apparatus determines respective ranking ranges for each of a plurality of data buckets. In various embodiments, a data bucket is a region of a physical memory storage used to temporarily store data until the data is ingested and/or processed via a corresponding ingestion engine (e.g., an ingestion engine dedicated to ingesting instances of map update data and/or batches of instances of map update data from the corresponding data bucket using dedicated computational resources). In various embodiments, the ranking ranges are determined based on an average processing rate of the plurality of data buckets, a desired processing rate for one or more high priority data buckets, a minimum processing rate for one or more high priority data buckets, a maximum processing rate for one or more low priority data buckets, and/or the like.

The update apparatus determines respective instance rankings for each received instance of map update data based at least in part on the region ranking corresponding to the geographic region indicated by the respective instance of location data and/or geographic region identifier. In an example embodiment, an instance of map update data is assigned an instance ranking that is equivalent to the region ranking for the geographic region corresponding to the location indicated by the instance of location data and/or the geographic region identifier of the instance of map update data. In an example embodiment, the instance ranking assigned to an instance of map update data is determined based on the region ranking for the geographic region corresponding to the location indicated by the instance of location data and/or the geographic region identifier of the instance of map update data and one or more of (a) a geographic area associated with the particular instance of map update data (e.g., determined based on the location indicated by the corresponding instance of location data), the geographic area being within the geographic region of the plurality of defined geographic regions associated with the particular instance of map update data, (b) an entity that generated the particular instance of map update data, or (c) a map component type to which the particular instance of map update data corresponds. For example, instances of map update information that comprise respective map component types indicating the corresponding map data corresponds to a freeway, highway, and/or other high volume roadway (and/or a segment thereof) may be assigned an instance ranking indicating a higher priority than instance of map update information that comprise respective map component types indicating the corresponding map data corresponds to residential roads and/or other low volume roadways (and/or a segment thereof).

The respective instances of map update data are then stored to respective data buckets based on the respective instance ranking and the ranking ranges corresponding to the data buckets. For example, an instance of map update assigned an instance ranking of 12 is stored to a data bucket having an assigned a ranking range of 10 to 15. Each data bucket is then ingested by computational resources dedicated to the respective data bucket. For example, a first set of processing elements are configured to ingest instances of map update data from a first data bucket and a second set of processing elements are configured to ingest instances of map update data from a second data bucket. In various embodiments, the first set of processing elements and the second set of processing elements do not overlap (e.g., do not share any processing elements or have any processing elements in common).

In various embodiments, the update apparatus generates batches of instances of map update data within each data bucket. For example, by clustering the instances of map update data stored to a particular data bucket based on the respective instances of location data, for example, the instances of map update data within particular data bucket may be organized into batches. The batches may then be ingested and/or processed (e.g., via an ingestion engine) using a batch processing technique. In various embodiments, such batch processing of location-clustered batches reduces the computational resources needed to process the batch of instances of map update data due to, for example, the need to access less map data from the geographical database storing the digital map to process each batch (e.g., since the instances of map update data within the batch are likely to correspond to overlapping map data).

When instances of map update data are ingested, the instances of map update data may be analyzed to determine whether the respective instances are likely to be inaccurate activity (e.g., provided by a bad faith actor, provided by a probe device having a malfunctioning sensor and/or experiencing inaccurate positioning, and/or the like), used to generate and/or update a digital map, and/or the like. As the instances of map update data are ingested (e.g., as a result thereof), a digital map is generated and/or updated. In various embodiments, the update apparatus provides at least a portion of the digital map and/or map updates to one or more servers, mobile devices, user computing devices, Cloud-based services, and/or the like. The servers, mobile devices, user computing devices, Cloud-based services, and/or the like may use at least a portion the digital map (and/or a digital map that is updated based on the map update(s)) to perform one or more positioning and/or navigation-related functions. The navigation-related functions can correspond to vehicle navigation or other types of navigation. Some non-limiting examples of positioning and/or navigation-related functions include determining a position estimate, providing a route (e.g., via a user interface), localization, route determination, lane level route determination, operating a vehicle along a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, and/or the like.

By controlling which data buckets instances of map update data are assigned to for ingestion and/or processing, instances of map update data with a higher priority and/or corresponding to geographic regions and/or a geographic area within a geographic region where the timeliness and/or freshness of the updated digital map is a priority can be assigned to data buckets having higher processing rates (e.g., more computational resources and/or less volume of instances of map update data for processing) while continuing to process lower priority instances of map update data so as to not create a backlog of instances of map update information for processing.

As should be understood, a first plurality of instances of map update data are received during a first time window. During a second time window that is immediately preceded by the first time window, a second plurality of instances of map update data are received. Thus, in various embodiments, the various processes described herein are executed in a continuous manner and/or iterated over the various time windows. For example, the one or more measures and/or combinations thereof used to determine region rankings may be updated in a continuous and/or (near) real-time manner during the execution of the ingestion controlling process.

Conventional techniques for ingesting instances of map update data, especially for crowd-sourced map generation and/or update schemes, tend to ingest and/or process instances of map data in the order in which the instances are received. However, this may mean than higher priority instances of map update data, corresponding to higher priority geographic regions, higher priority geographic areas, higher priority map components, and/or the like are ingested with the same processing rate as lower priority instances of map update data. Thus, technical problems exist regarding how to prioritize the ingestion of instances of map update data.

Various embodiments described herein provide technical solutions to these technical problems. For example, various embodiments determine region rankings for respective geographic regions, and based those region rankings, determine instance rankings for respective instances of map update data. Data buckets are defined that are associated with dedicated computational resources. Ranking ranges are determined for respective data buckets such that instances of map update data can be assigned to data buckets based on the respective instance ranking and the ranking ranges. Thus, higher priority instances of map update data can be assigned to data buckets having more computational resources, faster processing speed, and/or a smaller volume of instances of map update data.

Various embodiments provide the additional technical advantage of increased efficiency of batch processing within the data buckets by generating batches of instances of map update data that correspond to the same geographic region and/or geographic area with the geographic region, and/or that correspond to overlapping (e.g., geographically overlapping) map data of the digital map.

Various embodiments provide the additional technical advantage of being able to throttle or bottleneck the ingestion of instances of map update data that are possibly associated with inaccurate activity (e.g., provided by bad faith actors, provided by a probe device having a malfunctioning sensor and/or experiencing inaccurate positioning, and/or the like), such that the instances of map update data that are likely associated with inaccurate activity can be identified prior to ingestion and/or processing thereof, for example. Thus, various embodiments provide tools for mitigating and/or reducing the effect of inaccurate activity on the digital map.

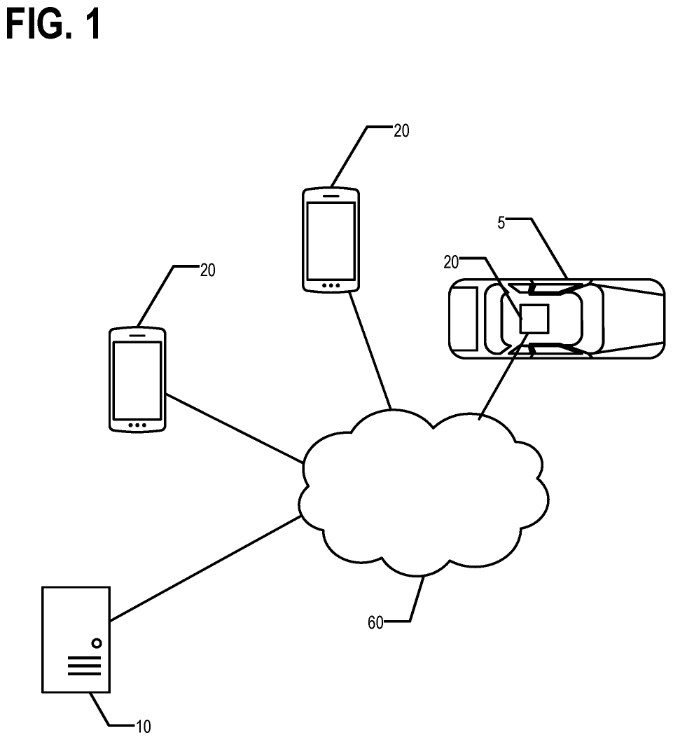

FIG. 1 provides an illustration of an example system that can be used in conjunction with various embodiments of the present invention. As shown in FIG. 1, the system includes one or more update apparatuses 10, one or more probe devices 20, one or more networks 60, and/or the like. In an example embodiment, the update apparatus 10 is a server, group of servers, distributed computing system, part of a Cloud-based computing system, and/or other computing system. In various embodiments, a probe device 20 is a smartphone, a tablet, a personal digital assistant (PDA), laptop, navigation system, part of a vehicle control and/or advanced driver assistance system (ADAS), and/or the like. In an example embodiment, one or more probe devices 20 may be physically associated with, coupled to, onboard, and/or part of a respective vehicle 5. In an example embodiment, a probe device 20 is configured to perform one or more positioning and/or navigation-related functions based on a digital map that is generated by the update apparatus 10 and/or updated based on map updates generated by the update apparatus 10. In various embodiments, the update apparatus 10 communicates with one or more probe devices 20 via one or more wired or wireless networks 60.

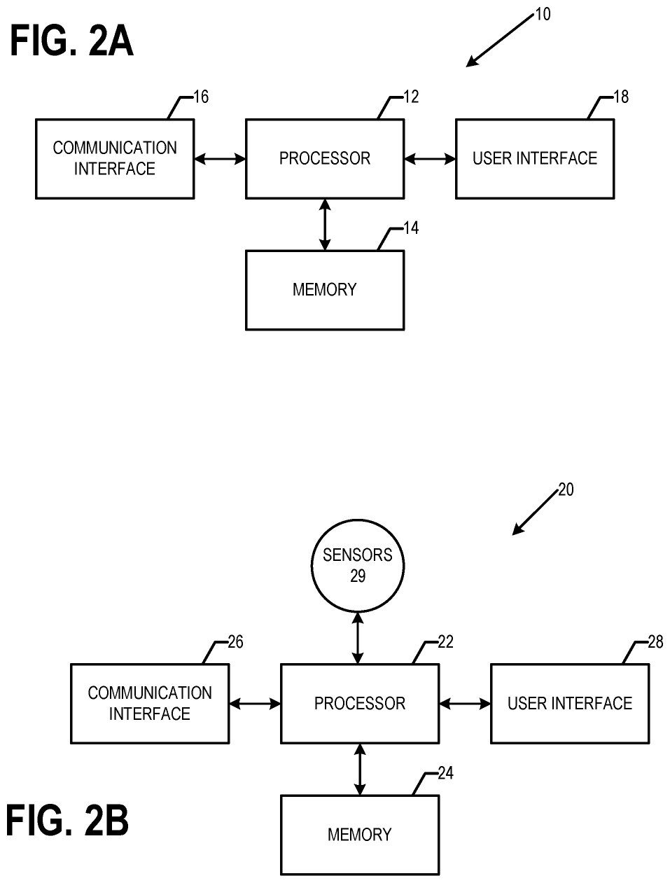

In an example embodiment, an update apparatus 10 may comprise components similar to those shown in the example update apparatus 10 diagrammed in FIG. 2A. In an example embodiment, the update apparatus 10 is configured to receive instances of map update data, determine respective regional rankings corresponding to geographic regions, define respective ranking ranges for data buckets, determine respective instance rankings corresponding to individual instances of map update data, assign instances of map update data to respective data buckets based on the respective ranking ranges corresponding to the data buckets and the respective instance rankings corresponding to the instances of map update data, identify instances of map update data that are likely associated with inaccurate activity, (batch) ingest and/or process the instances of map update data from the data buckets using data bucket specific and/or dedicated computational resources, generate a digital map and/or map updates for the digital map based on the instance of map update data, and/or the like. In an example embodiment, the update apparatus 10 is configured to identify contentious map updates, generate and provide update confirmation requests, receive update confirmations, ingest and/or process update confirmations, and/or the like.

For example, as shown in FIG. 2A, the update apparatus 10 may comprise a processor 12, memory 14, a user interface 18, a communications interface 16, and/or other components configured to perform various operations, procedures, functions, or the like described herein. In various embodiments, the update apparatus 10 stores a geographical database, digital map, and/or computer program code and/or instructions for performing various functions described herein, and/or the like (e.g., in memory 14), for example. In at least some example embodiments, the memory 14 is non-transitory.

In an example embodiment, the probe device 20 is configured to generate and provide instances of map update data for receipt by the update apparatus, receive at least a portion of a digital map and/or map update for updating at least a portion of a digital map, use the at least a portion of the digital map to perform one or more positioning and/or navigation-related functions, and/or the like.

In an example embodiment, the probe device 20 is a smartphone, tablet, laptop, PDA, navigation system, desktop computer, client device, Internet of things (IoT) device, part of a vehicle control and/or advanced driver assistance system (ADAS), and/or the like. In an example embodiment, as shown in FIG. 2B, the probe device 20 may comprise a processor 22, memory 24, a communications interface 26, a user interface 28, one or more sensors 29 and/or other components configured to perform various operations, procedures, functions or the like described herein. In various embodiments, the probe device 20 stores at least a portion of one or more digital maps (e.g., geographic databases, positioning maps, radio maps, and/or the like) and/or computer executable instructions for generating and/or providing instances of map update data, performing one or more positioning and/or navigation-related functions, and/or the like in memory 24. In at least some example embodiments, the memory 24 is non-transitory.

In various embodiments, the sensors 29 comprise one or more motion and/or IMU sensors, one or more GNSS sensors, one or more radio sensors, one or more image sensors, one or more audio sensors, and/or other sensors. In an example embodiment, the one or more motion and/or IMU sensors comprise one or more accelerometers, gyroscopes, magnetometers, barometers, and/or the like. In various embodiments, the one or more GNSS sensor(s) are configured to communicate with one or more GNSS satellites and determine GNSS-based position estimates and/or other information based on the communication with the GNSS satellites. In various embodiments, the one or more radio sensors comprise one or more radio interfaces configured to observe and/or receive signals generated and/or transmitted by one or more access points and/or other computing entities. For example, the one or more interfaces may be configured (possibly in coordination with processor 22) to determine a locally unique identifier, globally unique identifier, and/or operational parameters of an access point observed by the radio sensor(s). As used herein, a radio sensor observes an access point by receiving, capturing, measuring and/or observing a signal generated and/or transmitted by the access point. In an example embodiment, the interface of a radio sensor may be configured to observe one or more types of signals such as generated and/or transmitted in accordance with one or more protocols such as 5G, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface of a radio sensor may be configured to observe signals of one or more modern global cellular formats such as GSM, WCDMA, TD-SCDMA, LTE, LTE-A, CDMA, NB-IoT and/or non-cellular formats such as WLAN, Bluetooth, Bluetooth Low Energy (BLE), Zigbee, Lora, and/or the like. For example, the interface(s) of the radio senor(s) may be configured to observe radio, millimeter, microwave, and/or infrared wavelength signals. In an example embodiment, the interface of a radio sensor may be coupled to and/or part of a communications interface 26. In various embodiments, the sensors 29 may further comprise one or more image and/or visual sensors configured to capture visual samples, such as digital camera(s), 3D cameras, 360° cameras, and/or image sensors. In various embodiments, the one or more sensors 29 may comprise various other sensors such as two dimensional (2D) and/or three dimensional (3D) light detection and ranging (LiDAR)(s), long, medium, and/or short range radio detection and ranging (RADAR), ultrasonic sensors, electromagnetic sensors, (near-) infrared (IR) cameras. In various embodiments, the one or more sensors 29 comprise one or more audio sensors such as one or more microphones.

Each of the components of the system may be in electronic communication with, for example, one another over the same or different wireless or wired networks 60 including, for example, a wired or wireless Personal Area Network (PAN), Local Area Network (LAN), Metropolitan Area Network (MAN), Wide Area Network (WAN), cellular network, and/or the like. In an example embodiment, a network 60 comprises the automotive cloud, digital transportation infrastructure (DTI), radio data system (RDS)/high definition (HD) radio or other digital radio system, and/or the like. For example, a probe device 20 may be in communication with an update apparatus 10 via the network 60. For example, a probe device 20 may communicate with the update apparatus 10 via a network, such as the Cloud. For example, the Cloud may be a computer network that provides shared computer processing resources and data to computers and other devices connected thereto.

For example, the probe device 20 provides instances of map update data such that the update apparatus 10 receives the instances of map update data via the network 60. In an example embodiment, a probe device 20 provides an update confirmation such that the update apparatus 10 receives the update confirmation via the network 60. For example, the update apparatus 10 provides at least a portion of a digital map and/or a map update for updating the digital map for receipt by one or more probe devices 20, servers, mobile devices, user computing devices, Cloud-based services via the network 60. In an example embodiment, the update apparatus 10 provides an update confirmation request such that one or more probe devices 20 receive the update confirmation request via the network 60.

Certain example embodiments of the update apparatus 10 and probe device 20 are described in more detail below with respect to FIGS. 2A and 2B.

### II. Example Operation(s)

In various embodiments, a probe device 20 generates and/or captures sensor data via one or more sensors 29. Based on the sensor data, and possibly on at least a portion of a digital map stored by the probe device 20 (e.g., in memory 24), the probe device 20 generates instances of map update data. For example, the probe device 20 may comprise means, such as processor 22, memory 24, sensors 29, and/or the like, for generating and/or capturing sensor data and generating one or more instances of map update data based thereon.

In various embodiments, an instance of map update data comprises an instance of location data and map data. In various embodiments, the instance of location data indicates a location of the probe device 20 when the probe device 20 generated and/or captured the sensor data and/or generated the map data based on the sensor data. In an example embodiment, the instance of location data comprises a geographical location (e.g., latitude, longitude, and/or elevation/altitude) of a position estimate indicating the location of the probe device when the probe device 20 generated and/or captured the sensor data and/or generated the map data based on the sensor data. In an example embodiment, the instance of location data comprises a geographic region identifier configured to indicate and/or identify the geographic region within which the probe device 20 was located when the probe device 20 generated and/or captured the sensor data and/or generated the map data based on the sensor data. In various embodiments, the instance of location data is determined based on a GNSS-based position estimate, a hybrid (e.g., based on multiple types of sensors) position estimate, an IMU and/or motion sensor-based position estimate, a radio-based position estimate, a user indicated position estimate (e.g., based on user selection of a location based on user interaction with a graphical user interface or other user input device), and/or other position estimate.

In various embodiments, an instance of map update data comprises one or more elements of map data corresponding to one or more map components (and/or potential map components) of the digital map. In various embodiments, the map data corresponds to sensor data and/or observation of one or more features, road side barriers, traffic signals, signs, road surface markings, pole-like objects (e.g., telephone poles, sign posts, etc.), pavement and/or driving surface edge, lane markings, construction markings, buildings, parking areas, points of interest (POIs), probe device trajectory, network access points and/or radio nodes, and/or the like. In an example the map data is provided as a maplet. In various embodiments, the one or more elements of map data may be formatted in a variety of formats.

In various embodiments, the probe device 20 provides (e.g., transmits) the instance of map update data (or possibly a plurality of instances of map update data) for receipt by the update apparatus 10. In various embodiments, the probe device 20 provides instances of map update data in (near) real time with respect the generation of the instances of map update data and/or upon determination that the probe device 20 is capable of communicating via one or more wired and/or wireless networks 60 after generation of the instances of map update data. In various embodiments, the probe device 20 comprises means, such as processor 22, memory 24, communication interface 26, and/or the like, for providing the instance(s) of map update data.

In various embodiments, a plurality of probe devices 20 generate and provide instances of map update data over various periods of time. Thus, the update apparatus 10 receives a respective plurality of instances of map update data corresponding to a plurality of geographic regions of a plurality of defined geographic regions during respective time windows. In an example embodiment, the time windows have a set temporal length. In an example embodiment, the temporal length of a time window may be adjusted based on a rate at which instances of map update data are being received, changes in the rate at which instances of map update data are being received, and/or the like.

In various embodiments, the update apparatus 10 pre-processes the instances of map update data by assigning each instance of map update data a respective instance ranking and then assigning the respective instances of map update data to respective data buckets based on the respective instance rankings assigned to the instances of map update data and the respective ranking ranges assigned to the data buckets. In various embodiments, the instance ranking assigned to an instance of map update data is determined at least in part based on a region ranking assigned to the geographic region to which the instance of map update data corresponds (e.g., as determined based on the instance of location data of the instance of map update data). In various embodiments, the update apparatus 10 continuously and/or periodically (e.g., one or multiple times each time window) determines respective region rankings for the plurality of defined geographic regions and respective ranking ranges for the plurality of data buckets. The instances of map update data are then ingested and/or processed from their respective data buckets using data bucket specific and/or dedicated computational resources.

The ingestion and/or processing of the instances of map update data causes the digital map to be generated and/or updated. For example, the update apparatus 10 may generate map components corresponding to features, road segments and/or lanes, and/or the like indicated by the elements of map data of the instances of map update data. For example, the update apparatus 10 may update information/data corresponding to one or more maps components based on the elements of map data of the instances of map update data. In various embodiments, the update apparatus 10 periodically and/or in a triggered manner provides (e.g., transmits) at least a portion of the digital map and/or map updates configured to update one or more portions of the digital map.

In various embodiments, one or more probe devices 20, servers, mobile devices, user computing devices, Cloud-based services, and/or the like receive the at least a portion of the digital map and/or map updates. The one or more probe devices 20, servers, mobile devices, user computing devices, Cloud-based services, and/or the like may then use at least a portion the digital map (and/or a digital map that is updated based on the map update(s)) to perform one or more positioning and/or navigation-related functions. The navigation-related functions can correspond to vehicle navigation or other types of navigation. Some non-limiting examples of positioning and/or navigation-related functions include determining a position estimate, providing a route (e.g., via a user interface), localization, route determination, lane level route determination, operating a vehicle along a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, and/or the like.

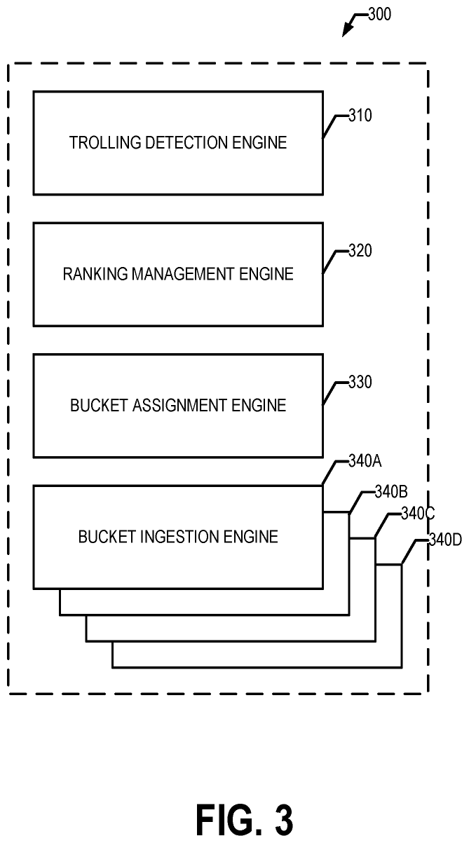

FIG. 3 provides a schematic diagram of a controlled ingestion program 300, in accordance with an example embodiment. In various embodiments, the update apparatus 10 stores computer-executable program code and/or instructions that, when executed by one or more processors thereof, causes the controlled ingestion program 300 to control the ingestion and/or processing of instances of map update data received by the update apparatus 10. In various embodiments, the controlled ingestion program 300 comprises a trolling detection engine and/or module 310 configured to identify instances of map update data that are likely to be part of inaccurate activity. In various embodiments, the controlled ingestion program 300 comprises a rank management engine and/or module 320 configured to determine region rankings and/or instance rankings based on various measures and/or combinations thereof. In various embodiments, the ingestion program 300 comprises a bucket assignment engine and/or module 330 configured to determine the respective ranking ranges assigned to the plurality of data buckets. In various embodiments, the controlled ingestion program 300 comprises one or more bucket ingestion engines and/or modules 340 each configured to generate batches of instances of map update data within a respective data bucket and/or cause the ingestion and/or processing of the instances of map update data from the respective data bucket using the bucket specific and/or dedicated computational resources.

In various embodiments, the trolling detection engine and/or module 310 is configured to determine a respective measure of inaccurate activity for one or more geographic regions of the plurality of defined geographic regions. In various embodiments, the trolling detection engine and/or module 310 comprises and/or is in communication with a machine model configured to identify inaccurate activity. In various embodiments, inaccurate activity comprises the submission of falsified, spoofed, and/or the like instances of map update data by a bad faith actor, the submission of instances of map update data by a probe device 20 having a malfunctioning sensor and/or experiencing inaccurate positioning, and/or the like. In an example embodiment, the probe device 20 may be experiencing inaccurate positioning due to manipulation of signals (e.g., GNSS signals, radio frequency signals, and/or the like) used to determine a position estimate and/or malware operating on the probe device 20 interfering with the position estimate determination.

In various embodiments, a machine model (e.g., trained via a machine learning technique) is used to identify instances of map update data that are likely to be inaccurate activity. In various embodiments, the measure of inaccurate activity for a geographic region is determined based on the number, percentage, and/or the like of instances of map data corresponding to the geographic region that are identified as likely to be inaccurate activity.

In an example embodiment, the measure of inaccurate activity for a geographic region is determined based on the rejection rate for the geographic region experienced during integration of map components generated based on the ingesting of instances of map update data corresponding to the geographic region. For example, in an example embodiment, when an instance of map update data is ingested, a new map component is generated based on the one or more elements of map data of the instance of map update data. One or more machine learning models and/or map rules may be used to compare the new map component to existing map components of the digital map and/or other new map components generated based on other instances of map update data that are being ingested. Based on output of the one or more machine learning models and/or the map rules, the update apparatus 10 determines whether the new map component should be integrated into the digital map, used to modify an existing map component, or rejected. In various embodiments, a map component is a data object comprising information/data corresponding to and/or describing individual and/or aggregated observations of real world features and/or things. The rejection rate for the geographic region is determined based on the number, percentage, and/or per time value of new map components that are rejected.

As should be understood, the rejection rate for a region is time dependent. For example, the rejection rate during a first time window may be different from the rejection rate during a second time window. In an example embodiment, a base level rejection rate is defined for one or more geographic regions. For example, a respective base level rejection rate may be defined for each geographic region of the plurality of defined geographic regions. In another example, one base level rejection rate is defined for a multiple geographic regions of the plurality of defined geographic regions. In an example embodiment, when the rejection rate for a geographic region surpasses the base level rejection rate, the geographic region is considered to be experiencing inaccurate activity and the measure of inaccurate activity is determined to indicate a severity of the inaccurate activity (e.g., how much over the base level rejection rate the rejection rate for the geographic region is). In an example embodiment, a ratio of the rejection rate during a first period of time to the rejection rate during second period of time (e.g., a ratio of the rejection rate during a first time window to the rejection rate during a second time window that is immediately preceded by the first time window) for a geographic region is determined and used to determine the measure of inaccurate activity for the geographic region.

In various embodiments, the controlled ingestion program 300 comprises a ranking management engine 320. In various embodiments, the ranking management engine 320 is configured to generate, determine, and/or assign region rankings to the plurality of defined geographic regions and/or instance rankings to instances of map update data.

In various embodiments, the region rankings are determined based on one or more and/or a combination of one or more of (a) a volume measure corresponding to and/or determined at least in part on a number of the plurality of instances of map update data associated with a respective geographic region of the plurality of defined geographic regions received during a particular time period corresponding to the time window (e.g., during the preceding time window, during the portion of the time window that has passed, in a sliding time period, and/or the like), (b) a measure of map update activity corresponding to the respective geographic region during the particular time period corresponding to the time window, (c) a measure of inaccurate activity corresponding to the respective geographic region during the particular time period corresponding to the time window, (d) a weight assigned to the respective geographic region; or (e) an interest density corresponding to the respective geographic region, and/or the like.

In various embodiments, the volume measure for a particular geographic region is determined based at least in part on the number of the plurality of instances of map update data that are associated with the particular geographic region. In various embodiments, the volume measure is determined based on the fraction and/or percentage of instances of map update data of the plurality of instances of map update data received by the update apparatus 10 during the particular time period. In an example embodiment, the volume measure is determined based on a ratio of the number, fraction, and/or percentage of the instances of map update data of the plurality of instances of map update data received by the update apparatus 10 during the particular time period to the number, fraction, and/or percentage of the instances of map update data of the plurality of instances of map update data received by the update apparatus 10 during another time period (e.g., the time period immediately preceding the particular time period, and/or the like).

In various embodiments, the measure of map update activity for a particular geographic region during the particular time period corresponding to the time window is a measure of how much the portion of the digital map corresponding to the particular geographic region is changing. In various embodiments, the measure of map update activity for a particular geographic region during the particular time period corresponding to the time window is determined based on the number of edits (e.g., additions of map components, updating and/or editing of map components, removal of map components, and/or the like) during the particular time period. For example, in an example embodiment, the measure of map update activity for the particular geographic region during the particular time period is a ratio of the number of map components in the particular geographic region deleted during the particular time period to the number of map components in the particular geographic region added and/or edited during the particular time period. In an example embodiment, the measure of map update activity for the particular geographic region during the particular time period is a normalized ratio of the number of map components in the particular geographic region deleted during the particular time period to the number of map components in the particular geographic region added and/or edited during the particular time period. For example, the measure of map update activity for the particular geographic region during the particular time period is the ratio of the number of map components in the particular geographic region deleted during the particular time period to the number of map components in the particular geographic region added and/or edited during the particular time period multiplied by a constant (e.g., 100, in an example embodiment).

In various embodiments, the measure of inaccurate activity corresponding to the particular geographic region during the particular time period corresponding to the time window is determined based on the output of the trolling detection engine 310. In various embodiments, the measure of inaccurate activity is used to throttle, bottleneck, and/or slow the ingestion of instances of map update data corresponding to geographic regions experiencing elevated levels of inaccurate activity such that the trolling detection engine 310 can identify and flag the instances of map update data that are likely inaccurate activity.

In various embodiments, the weight assigned to the particular geographic region indicates a general priority of the particular geographic region. For example, the timeliness of map updates for a first geographic region is more important that the timeliness of map updates for a second geographic region, the first geographic region is assigned a weight indicting the higher general priority than the weight assigned to the second geographic region. In various embodiments, the weight assigned to the particular geographic region does not change from one time window to another time window. In an example embodiment, the weight of a particular geographic region indicates a time value of integration for the portion of the digital map corresponding to the particular geographic region. In an example embodiment, the weight assigned to a particular geographic region may be occasionally updated as the importance of timeliness of map updates in the particular region change, and/or the like. For example, a geographic region known to have a large number of self-driving vehicles may have a higher general priority than a geographic region known to have only a few or no self-driving vehicles. In another example, the digital map is provided in portions corresponding to respective geographic regions and respective geographic regions for which the corresponding portion of the digital map is requested and/or accessed frequently are assigned a weight indicating a higher general priority than geographic regions for which the corresponding portion of the digital map is not requested and/or accessed as frequently.

In various embodiments, an interest density corresponding to a particular geographic region is a measure of a density of the map components of interest in the portion of the digital map corresponding the geographic region. For example, interest density may correspond to an average spatial density of map components of a map component type of interest (e.g., POIs, road segments, and/or the like) in the particular geographic region. For example, the interest density may correspond to an average spatial density of all map components in the particular geographic region. In an example embodiment, the interest density is a ratio of the number of map components located in the particular geographic region to the total number of map components in the digital map. In various embodiments, the interest density for a geographic region is general constant from one time window to another. In an example embodiment, the interest density is occasionally updated (e.g., once a day, once a week, once a month, once a quarter (e.g., every three months), and/or the like).

In an example embodiment, the respective region rankings for the plurality of defined geographic regions is determined based on a combination of respective (a) volume measures V, (b) measures of map update activity A, (c) measures of inaccurate activity T, (d) weights W, and (e) interest densities D. For example, region ranking Rᵢ for the ith geographic region of the plurality of defined geographic regions for time window t is determined based on a combination of (a) the volume measure Vᵢ(t) for the ith geographic region, (b) the measure of map update activity Aᵢ(t) for the ith geographical region, (c) the measure of inaccurate activity Tᵢ(t) for the ith geographic region, (d) the weight Wᵢ for the ith geographic region, and the interest density Dᵢ for the In an example embodiment, the region ranking Rᵢ for ith particular region is determined by Rᵢ=f(Vᵢ(t), Aᵢ(t), Tᵢ(t))+Wᵢ+Dᵢ, where f is an application-specific function of the volume measure, the measure of map update activity, and the measure of inaccurate activity.

In an example embodiment, the region ranking for the particular region is further determined based at least on an error quotient e. In an example embodiment, the error quotient e is a constant and/or determined based on an error function. For example, the region ranking Rᵢ for ith particular region is determined by Rᵢ=f(Vᵢ(t), Aᵢ(t), Tᵢ(t)+Wᵢ+Dᵢ+e.

In various embodiments, the ranking management engine 320 is further configured to determine respective instance rankings for the plurality of instances of map update data. In various embodiments, each instance of map update data is assigned a respective instance ranking that is equivalent to the region ranking for the geographic region corresponding to the respective instance of map update data. In various embodiments, the instance ranking for a particular instance of map update data is determined based on the region ranking for the corresponding geographic region, a geographic area within which the location indicated by the instance of location data of the instance of map update data is located (the geographic area being a portion of the corresponding graphical region), an entity and/or probe device 20 that generated the particular instance of map update data, a map component type to which the particular instance of map update corresponds, and/or the like.

For example, a geographic region may comprise multiple geographic areas. A first geographic area within the geographic region may be relatively rural and/or a residential neighborhood and a second geographic area within the geographic region may be relatively urban and/or an area having a high density of POIs. Thus, the timeliness of the map updates in second geographic area may be more important than the timeliness of the map updates in the first geographic area. Thus, the instance ranking for instances of map update data corresponding to the second geographic area may be modified to indicate that increased importance.

For example, one or more instances of map update data provided by a first probe device 20 may be identified as inaccurate activity. The instance ranking assigned to other instances of map update data provided by the first probe device 20 may be configured to slow the ingestion of the instances of map update data provided by the first probe device 20.

For example, an instance of map update data may include a map component type indicating the type of map component to which the one or more elements of map data of the instance correspond. Various types of map components may be a higher priority for ingestion than other types of map components. For example, map components corresponding to road segments that are part of a highway or freeway or another high volume road may be a higher priority for ingestion than map components corresponding to road segments that are part of residential roads or another low volume road.

(a) a geographic area associated with the particular instance of update data, the geographic area being within the geographic region of the plurality of defined geographic regions associated with the particular instance of map update data, (b) an entity that generated the particular instance of map update data, or (c) a map component type to which the particular instance of map update data corresponds.

In various embodiments, the controlled ingestion program 300 comprises a bucket assignment engine 330. In various embodiments, the bucket assignment engine 330 is configured to determine the respective ranking ranges assigned to the plurality of data buckets. For example, the ranking ranges are determined based on an average processing rate of the plurality of data buckets, a desired processing rate for one or more high priority data buckets, a minimum processing rate for one or more high priority data buckets, a maximum processing rate for one or more low priority data buckets, and/or the like. In various embodiments, the ranking range for a data bucket is determined based on a hashify function h. For example, the hashify function h is configured to compute a particular bucket value based on the distribution of region rankings and/or instance rankings for a particular time period and/or time window. In other words, the hashify function is configured to map an instance ranking to a corresponding data bucket. In an example embodiment the rate of process rₚ for an instance of map update data having an instance ranking I is determined by rₚ=g(I,h)+e, where g is an application-specific function and e is the error quotient.

In various embodiments, the controlled ingestion program 300 comprises one or more bucket ingestion engines and/or modules 340 (e.g., 340A, 340B, 340C, 340D). In an example embodiment, a bucket ingestion engine and/or module 340 is associated with a particular data bucket. In various embodiments, a bucket ingestion engine and/or module 340 is configured to control the ingestion of instances of map update data assigned to and/or stored to the corresponding data bucket. For example, the bucket ingestion engine and/or module 340 is configured to pass instances of map update data from the corresponding data bucket to the computational resources dedicated to the data bucket. For example, computational resources may be dedicated for processing instances of map update data of a particular data bucket. For example, a first set of processing elements are configured to ingest instances of map update data from a first data bucket and a second set of processing elements are configured to ingest instances of map update data from a second data bucket. For example, the first set of processing elements are configured to not ingest instances of map update data from the second data bucket. In various embodiments, the computational resources dedicated to a first data bucket include at least a portion of a computer-readable memory and one or more processing elements. In various embodiments, a processing element is at least a portion of a processor. For example, a processing element may be core, coprocessor, microprocessor, processing circuitry instance, ASIC, FPGA, and/or the like, in various embodiments. For example, the update apparatus 10 comprises a plurality of processing elements and computer-readable memory portions with the plurality of processing elements divided into sets of processing elements. A set of processing elements and a computer-readable memory portion are assigned to each data bucket.

In various embodiments, the bucket ingestion engines and/or modules 340 are each configured to generate batches of instances of map update data within a respective data bucket. In an example embodiment, the batches are generated by clustering instances of map update data from the same geographic region. In an example embodiment, a batch of instances of map update data is generated within a particular data bucket by determining clusters of instances of map update data using a clustering algorithm and the instances of location data of the instances of map update data assigned to a particular data bucket. For example, the batches may preferentially comprise instances of map update data comprising instances of location data that spatially near one another (e.g., within the same geographic region, within the same geographic area, and/or the like). In an example embodiment, the batches may comprise instances of map update data comprising elements of map data corresponding to the same real world objects and/or features.

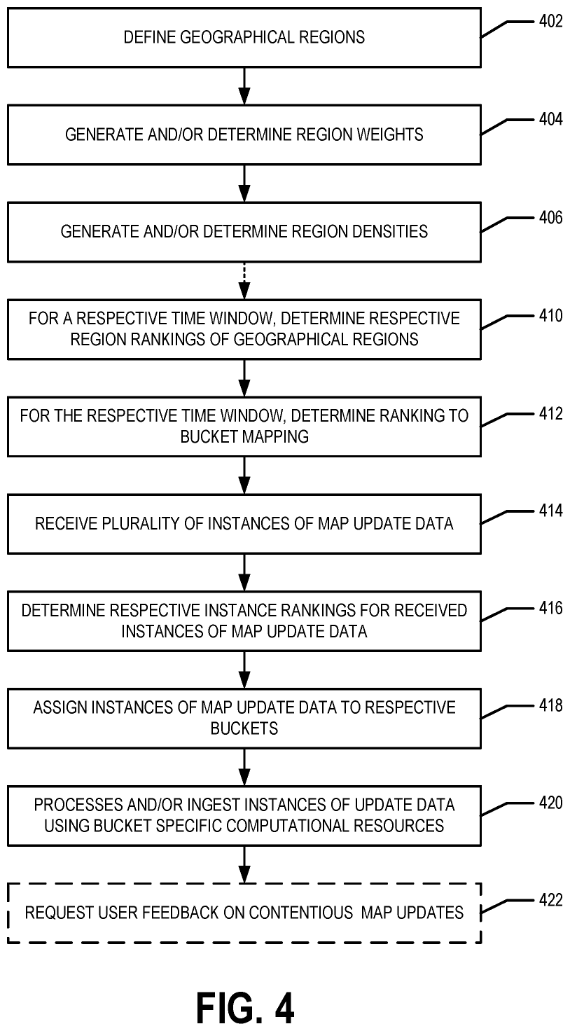

FIG. 4 provides a flowchart illustrating various processes, procedures, operations, and/or the like performed by an update apparatus 10, in accordance with various embodiments. Starting at step/operation 402, the update apparatus 10 defines a plurality of geographic regions to generate a plurality of defined geographic regions. For example, the update apparatus 10 comprises means, such as processor 12, memory 14, and/or the like, for defining a plurality of geographic regions. For example, the update apparatus 10 may define the plurality of geographic regions based on a tiling of a digital map, geopolitical borders and/or designations, and/or the like. In an example embodiment, the update apparatus 10 may define one or more geographic areas within one or more of the geographic regions.

At step/operation 404, the update apparatus 10 generates, determines, and/or assigns respective weights for each geographic region of the plurality of defined geographic regions. For example, the update apparatus 10 comprises means, such as processor 12, memory 14, communication interface 16, user interface 18, and/or the like, for generating, determining, and/or assigning respective weights for each geographic region of the plurality of defined geographic regions. For example, the update apparatus 10 may operate the ranking management engine 320 to determine and/or assign a weight for a particular geographic region. In an example embodiment, the weight generated, determined, and/or assigned for the particular region is generated, determined, and/or assigned based on user input (e.g., received via the communication interface 16 and/or user interface 18) and/or another indication of the general priority and/or relative importance of the timeliness of map updates in the particular region.

At step/operation 406, the update apparatus 10 generates, determines, and/or assigns respective interest densities for each geographic region of the plurality of defined geographic regions. For example, the update apparatus 10 comprises means, such as processor 12, memory 14, communication interface 16, user interface 18, and/or the like, for generating, determining, and/or assigning respective interest densities for each geographic region of the plurality of defined geographic regions. For example, the update apparatus 10 may operate the ranking management engine 320 to determine and/or assign an interest density for a particular geographic region. In an example embodiment, the interest density generated, determined, and/or assigned for the particular region is generated, determined, and/or assigned based map data read, accessed, and/or extracted from the digital map and corresponding to the particular region.

At step/operation 410, the update apparatus 10 determines respective region rankings for each geographic region of the plurality of defined geographic regions for a respective time window. For example, the update apparatus 10 comprises means, such as processor 12, memory 14, and/or the like, for determining respective region rankings for each geographic region of the plurality of defined geographic regions for a respective time window. For example, the update apparatus 10 may operate the ranking management engine 320 to determine respective region rankings for each of geographic regions of the plurality of defined geographic regions for the respective time window. For example, the region ranking for a particular geographic region for a particular time window is determined based at least in part on one or more and/or a combination of one or more of (a) a volume measure corresponding to and/or determined at least in part on a number of the plurality of instances of map update data associated with the particular geographic region received during the time period corresponding to the particular time window (e.g., during the preceding time window, during the portion of the time window that has passed, in a sliding time period, and/or the like), (b) a measure of map update activity corresponding to the particular geographic region during the time period corresponding to the particular time window, (c) a measure of inaccurate activity corresponding to the particular geographic region during the time period corresponding to the particular time window, (d) a weight assigned to the particular geographic region, (e) an interest density corresponding to the particular geographic region, (f) an error quotient, and/or the like.

At step/operation 412, the update apparatus 10 determines a ranking to data bucket mapping for a respective time window. For example, the update apparatus 10 comprises means, such as processor 12, memory 14, and/or the like, for determining a ranking to data bucket mapping for a respective time window. For example, the update apparatus 10 operates the bucket assignment engine 330 to determine respective region rankings for each geographic region of the plurality of defined geographic regions for a respective time window.

At step/operation 414, the update apparatus 10 receives a plurality of instances of map update data during a time window. For example, the update apparatus 10 comprises means, such as processor 12, memory 14, communication interface 16, and/or the like, for receiving a plurality instances of map update data during a time window. For example, one or more probe devices 20 generate and provide instances of map update data such that the update apparatus 10 receives a plurality of instances of map update data during the respective time window.

At step/operation 416, the update apparatus 10 determines respective instance rankings for each instance of map update data of the plurality of instances of map update data for the respective time window. For example, the update apparatus 10 comprises means, such as processor 12, memory 14, and/or the like, for determining respective instance rankings for each instance of map update data received during the respective time window. For example, the update apparatus 10 may operate the ranking management engine 320 to determine respective instance rankings for each of the plurality instances of map update data received during the respective time window. For example, the instance ranking for a particular instance of map update data received during a particular time window is determined based at least in part on one or more and/or a combination of one or more of the region ranking for the corresponding geographic region for the particular time window, a geographic area corresponding to the instance of location data of the instance of map update data, an entity and/or probe device 20 that generated the particular instance of map update data, a map component type to which the particular instance of map update corresponds, and/or the like.

At step/operation 418, the update apparatus 10 assigns respective instances of map update data to corresponding data buckets. For example, the update apparatus 10 comprises means, such as processor 12, memory 14, and/or the like, for assigning respective instances of map update data to corresponding data buckets. For example, the update apparatus 10 assigns and/or stores a particular instance of map update data to a particular data bucket based on the instance ranking of the particular instance of map update data and the ranking range of the data bucket. For example, a particular instance of map update data is assigned to the data bucket for which the instance ranking of the particular instance of map update aligns with and/or is within the ranking range of the data bucket.

At step/operation 420, the update apparatus 10 processes and/or ingests the instances of map update data from the data buckets using data bucket specific and/or dedicated computational resources. For example, the update apparatus 10 comprises means, such as processor 12, memory 14, and/or the like, for processing and/or ingesting the instances of map update data from the data buckets using data bucket specific and/or dedicated computational resources. For example, the update apparatus 10 operates a bucket ingestion engine 340 corresponding to a particular data bucket generates batches of instances of map update data assigned to the particular data bucket, in an example embodiment. The bucket ingestion engine 340 corresponding to the particular data bucket provides instances of map update data and/or batches of instances of map update data to computational resources dedicated to the particular data bucket. For example, the computational resources dedicated to the particular data bucket comprise a portion of a computer-readable memory and one or more processing elements.

When instances of map update data are ingested, the instances of map update data may be analyzed to determine whether the respective instances are likely to be inaccurate activity (e.g., provided by a bad faith actor, provided by a probe device having a malfunctioning sensor and/or experiencing inaccurate positioning, and/or the like), used to generate and/or update a digital map, and/or the like. As the instances of map update data are ingested (e.g., as a result thereof), a digital map is generated and/or updated. In various embodiments, the update apparatus provides at least a portion of the digital map and/or map updates to one or more servers, mobile devices, user computing devices, Cloud-based services, and/or the like. The servers, mobile devices, user computing devices, Cloud-based services, and/or the like may use at least a portion the digital map (and/or a digital map that is updated based on the map update(s)) to perform one or more positioning and/or navigation-related functions. The navigation-related functions can correspond to vehicle navigation or other types of navigation. Some non-limiting examples of positioning and/or navigation-related functions include determining a position estimate, providing a route (e.g., via a user interface), localization, route determination, lane level route determination, operating a vehicle along a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, and/or the like.

In an example embodiment, when an instance of map update data is ingested, a new map component is generated based on the one or more elements of map data of the instance of map update data. One or more machine learning models and/or map rules may be used to compare the new map component to existing map components of the digital map and/or other new map components generated based on other instances of map update data that are being ingested. Based on output of the one or more machine learning models and/or the map rules, the update apparatus 10 determines whether the new map component should be integrated into the digital map, used to modify an existing map component, or rejected. However, in some scenarios it may not be clear whether the new map component generated based on one or more instances of map update data should be used to update the digital map (e.g., integrated into the digital map, used to modify an existing map component, and/or the like) or rejected. Such scenarios, the new map component and/or the changes to the digital map that would be caused by updating the digital map based on the new map component are referred to as contentious map updates herein.

In various embodiments, when contentious map updates are identified, the update apparatus 10 determines whether to update the digital map based on the contentious map updates or to reject the contentious map updates based on user feedback. For example, at step/operation 422, an update apparatus 10 requests user feedback for contentious map updates. For example, an update apparatus 10 comprises means, such as processor 12, memory 14, communication interface 16, and/or the like for requesting user feedback on contentious map updates. For example, the update apparatus 10 generates and provides (e.g., transmits) an update confirmation request. For example, the update confirmation request may comprise at least a portion of a contentious map update and/or information relating thereto. The update apparatus 10 provides the update confirmation request such that one or more probe devices 20 receive the update confirmation request.

In various embodiments, the one or more probe devices 20 determine and provide respective update confirmations. In an example embodiment, a probe device 20 determines an update confirmation based on sensor data captured by the probe device 20 corresponding to real world object and/or feature described by the contentious map update. In an example embodiment, a probe device 20 requests user feedback via user interface 28 of the probe device 20 regarding whether the contentious map update accurately reflects the corresponding real world object and/or feature and the probe device determines an update confirmation based thereon. For example, the probe device 20 generates an update confirmation either indicating that the contentious map update does accurately describe and/or reflect the corresponding real world object and/or feature or that the contentious map update does not accurately describe and/or reflect the corresponding real world object and/or feature. The probe device 20 then provides (e.g., transmits) the update confirmation.

The update apparatus 10 receives a plurality of update confirmations responding to the update confirmation request. For example, the update apparatus 10 comprises means, such as processor 12, memory 14, communications interface 16, and/or the like for receiving the plurality of update confirmations responding to the update confirmation request. Based on the received update confirmations, the update apparatus 10 determines whether to apply the contentious map updates or to withhold (e.g., reject) the contentious map updates. In an example embodiment, when at least a threshold number of update confirmations have been received corresponding to a contentious map update, the update apparatus 10 may determine whether to reject the contentious map update (e.g., if most of the update confirmations indicate that the contentious map update does not accurately reflect and/or describe the corresponding real world object and/or feature) or to submit the contentious map update for use and/or consideration for use in updating the digital map (e.g., if at least a threshold number and/or percentage of the update confirmations indicate that the contentious map update does accurately reflect and/or describe the corresponding real world object and/or feature). In an example embodiment, the contentious map update is submitted for use and/or consideration for use in updating the digital map such that an instance ranking is determined and assigned to the contentious map update and the contentious map update is assigned to a data bucket based on the assigned instance ranking. The contentious map update is then ingested and/or processed from the data bucket such that the digital map is updated accordingly.

### III. Technical Advantages

Conventional techniques for ingesting instances of map update data, especially for crowd-sourced map generation and/or update schemes, tend to ingest and/or process instances of map data in the order in which the instances are received. However, this may mean than higher priority instances of map update data, corresponding to higher priority geographic regions, higher priority geographic areas, higher priority map components, and/or the like are ingested with the same processing rate as lower priority instances of map update data. Moreover, ingesting the instances of map update data simply based on the order of receipt may lead to inefficient processing of the instances of map update data. Additionally, inaccurate activity generated by bad faith actors or probe device malfunctions, may cause the ingestion of inaccurate instances of map update data. Thus, technical problems exist regarding how to prioritize the ingestion of instances of map update data, how to increase the efficiency with which instances of map update data are ingested, and/or how to reduce the effect of inaccurate activity on the digital map.

Various embodiments described herein provide technical solutions to the technical problems. For example, various embodiments determine region rankings for respective geographic regions, and based those region rankings, determine instance rankings for respective instances of map update data. Data buckets are defined that are associated with dedicated computational resources. Ranking ranges are determined for respective data buckets such that instances of map update data can be assigned to data buckets based on the respective instance ranking and the ranking ranges. Thus, higher priority instances of map update data can be assigned to data buckets having more computational resources, faster processing speed, and/or a smaller volume of instances of map update data.

Various embodiments provide additional technical advantage of increased efficiency of processing instances of map update data. In particular, in various embodiments, the instance ranking of an instance of map update data is primarily determined based on a region ranking for the corresponding geographic region. Thus, in various embodiments, instances of map update data corresponding to the same geographic region tend to be assigned to the same data bucket for ingestion. Thus, instances of map update data corresponding to overlapping map data (e.g., corresponding to the same geographic region) can be ingested together and/or in a string. For example, various embodiments provide the additional technical advantage of increased efficiency of batch processing within the data buckets by generating batches of instances of map update data that correspond to the same geographic region and/or geographic area with the geographic region, and/or that correspond to overlapping (e.g., geographically overlapping) map data of the digital map.

Various embodiments provide the additional technical advantage of being able to throttle or bottleneck the ingestion of instances of map update data that are possibly associated with inaccurate activity (e.g., provided by bad faith actors, provided by a probe device having a malfunctioning sensor and/or experiencing inaccurate positioning, and/or the like), such that the instances of map update data that are likely associated with inaccurate activity can be identified prior to ingestion and/or processing thereof, for example. Thus, various embodiments provide tools for mitigating and/or reducing the effect of inaccurate activity on the digital map.

Thus, various embodiments provide improved ingestion of instances of map update data by enabling prioritization of ingestion of instances of map update data, increasing the computational efficiency of ingesting the instances of map update data, and/or reducing the effect of inaccurate activity on the digital map.

### IV. Example Apparatus

The update apparatus 10 and/or probe device 20 of an example embodiment may be embodied by or associated with a variety of computing entities including, for example, a navigation system including a global navigation satellite system (GNSS), a cellular telephone, a mobile or smart phone, a personal digital assistant (PDA), a watch, a camera, a computer, an Internet of things (IoT) item, part of a vehicle control and/or advanced driver assistance system (ADAS), and/or the like. Additionally or alternatively, the update apparatus 10 and/or probe device 20 may be embodied in other types of computing devices, such as a server, a personal computer, a computer workstation, a laptop computer, a plurality of networked computing devices or the like, that are configured to generate and provide instances of map update data; ingest instances of map update data; generate, store, maintain, and/or update a digital map; provide at least a portion of the digital map and/or map updates configured to update at least a portion of the digital map; use at least a portion of the digital map to perform one or more positioning and/or navigation-related functions; and/or the like. In an example embodiment, a probe device 20 is a smartphone, tablet, laptop, PDA, part of a vehicle control and/or advanced driver assistance system (ADAS), and/or other mobile computing device and an update apparatus 10 is a server that may be part of a Cloud-based computing asset and/or processing system.

In some embodiments, the processor 12, 22 (and/or co-processors or any other processing circuitry assisting or otherwise associated with the processor) may be in communication with the memory device 14, 24 via a bus for passing information among components of the apparatus. The memory device may be non-transitory and may include, for example, one or more volatile and/or non-volatile memories. In other words, for example, the memory device may be an electronic storage device (e.g., a non-transitory computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the update apparatus 10 and/or probe device 20 may be embodied by a computing entity and/or device. However, in some embodiments, the update apparatus 10 and/or probe device 20 may be embodied as a chip or chip set. In other words, the update apparatus 10 and/or probe device 20 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12, 22 may be embodied in a number of different ways. For example, the processor 12, 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 12, 22 may include one or more processing cores configured to perform independently. A multi-core processor may enable multiprocessing within a single physical package. Additionally or alternatively, the processor 12, 22 may include one or more processors configured in tandem via the bus to enable independent execution of instructions, pipelining and/or multithreading. For example, the processor 12 of the update apparatus 10 comprises a plurality of processing elements (e.g., cores, coprocessors, microprocessors, processing circuitry instances, ASICs, FPGAs, and/or the like).

In an example embodiment, the processor 12, 22 may be configured to execute instructions stored in the memory device 14, 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the update apparatus 10 and/or probe device 20 may include a user interface 18, 28 that may, in turn, be in communication with the processor 12, 22 to provide a graphical user interface (GUI) and/or output to the user, such as one or more selectable user interface elements, at least a portion of a digital map, a result of a positioning and/or navigation-related function, navigable routes to a destination location and/or from an origin location, and/or the like, and, in some embodiments, to receive an indication of a user input. As such, the user interface 18, 28 may include one or more output devices such as a display, speaker, and/or the like and, in some embodiments, may also include one or more input devices such as a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 12, 22 (e.g., memory device 14, 24 and/or the like).

The update apparatus 10 and/or probe device 20 may optionally include a communication interface 16, 26. The communication interface 16, 26 may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In various embodiments, a update apparatus 10 and/or probe device 20 may comprise a component (e.g., memory 14, 24, and/or another component) that stores a digital map (e.g., in the form of a geographic database) comprising a first plurality of data records, each of the first plurality of data records representing a corresponding traversable map element (TME). At least some of said first plurality of data records map information/data indicate current traffic conditions along the corresponding TME. For example, the geographic database may include a variety of data (e.g., map information/data) utilized in various navigation functions such as constructing a route or navigation path, determining the time to traverse the route or navigation path, matching a geolocation (e.g., a GNSS determined location, a radio-based position estimate) to a point on a map, a lane of a lane network, and/or link, one or more localization features and a corresponding location of each localization feature, and/or the like. For example, the geographic database may comprise a radio map, such as a radio positioning map, comprising an access point registry and/or instances of access point information corresponding to various access points. For example, a geographic database may include road segment, segment, link, lane segment, or TME data records, point of interest (POI) data records, localization feature data records, access point data records, radio model data records, and other data records. More, fewer or different data records can be provided. In one embodiment, the other data records include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GNSS data associations (such as using known or future map matching or geo-coding techniques), for example. In an example embodiment, the data records may comprise nodes, connection information/data, intersection data records, link data records, POI data records, and/or other data records. In an example embodiment, the network device 10 may be configured to modify, update, and/or the like one or more data records of the geographic database. For example, the network device 10 may modify, update, generate, and/or the like map information/data corresponding to a radio map and/or TMEs, links, lanes, road segments, travel lanes of road segments, nodes, intersection, pedestrian walkways, elevators, staircases, and/or the like and/or the corresponding data records (e.g., to add or update updated map information/data including, for example, current traffic conditions along a corresponding TME; assign and/or associate an access point with a TME, lateral side of a TME, and/or representation of a building; and/or the like), a localization layer (e.g., comprising localization features), a registry of access points to identify mobile access points, and/or the corresponding data records, and/or the like.

In an example embodiment, the TME data records are links, lanes, or segments (e.g., maneuvers of a maneuver graph, representing roads, travel lanes of roads, streets, paths, navigable aerial route segments, and/or the like as can be used in the calculated route or recorded route information for determination of one or more personalized routes). The intersection data records are ending points corresponding to the respective links, lanes, or segments of the TME data records. The TME data records and the intersection data records represent a road network and/or other traversable network, such as used by vehicles, cars, bicycles, and/or other entities. Alternatively, the geographic database can contain path segment and intersection data records or nodes and connection information/data or other data that represent pedestrian paths or areas in addition to or instead of the vehicle road record data, for example. Alternatively and/or additionally, the geographic database can contain navigable aerial route segments or nodes and connection information/data or other data that represent an navigable aerial network, for example.

The TMEs, lane/road/link/path segments, segments, intersections, and/or nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end probe device developer, can perform compilation on a received geographic database in a delivery format to produce one or more compiled navigation databases.

### V. Apparatus, Methods, and Computer Program Products

As described above, FIG. 4 illustrates a flowchart of an update apparatus 10 and/or probe device 20, methods, and computer program products according to an example embodiment of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 14, 24 of an apparatus employing an embodiment of the present invention and executed by the processor 12, 22 of the respective apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for ingesting instances of map update data, the method comprising:
receiving, by an update apparatus, a plurality of instances of map update data during a time window, each instance of map update data of the plurality of instances of map update data associated with a respective geographic region of a plurality of defined geographic regions;
determining, by the update apparatus and for the time window, respective region rankings for the plurality of defined geographic regions, a region ranking for a particular geographic region determined based at least in part on one or more of (a) a number of the plurality of instances of map update data associated with a respective geographic region of the plurality of defined geographic regions, (b) a measure of map update activity corresponding to the respective geographic region, (c) a measure of inaccurate activity corresponding to the respective geographic region, (d) a weight assigned to the respective geographic region, or (e) an interest density corresponding to the respective geographic region,
determining, by the update apparatus and for the time window, respective ranking ranges for a plurality of data buckets;
assigning, by the update apparatus, a respective instance ranking to instances of map update data of the plurality of instances of map update data based at least in part on the respective geographic region associated with the respective instance of map update data and the respective region ranking determined for the respective geographic region;
assigning, by the update apparatus, instances of map update data to respective data buckets based on the respective instance rankings of the instances of map update data and the respective ranking ranges of the respective data buckets; and
ingesting, by the update apparatus, the respective instances of map update data based on the respective data buckets to cause a digital map maintained by the update apparatus to be updated.

2. The method of claim 1, wherein the respective instances of map data assigned to a particular data bucket are ingested using computational resources dedicated to the particular data bucket.

3. The method of claim 1, wherein a first group of processing elements are configured to ingest respective instances of map data assigned to a first bucket of the plurality of data buckets and a second group of processing elements are configured to ingest respective instances of map data assigned to a second bucket of the plurality of buckets.

4. The method of claim 1, wherein the region ranking for the particular geographic region is determined based at least in part on an error function.

5. The method of claim 1, wherein the respective instance ranking for a particular instance of map update data is determined based at least in part on at least one of (a) a geographic area associated with the particular instance of update data, the geographic area being within the geographic region of the plurality of defined geographic regions associated with the particular instance of map update data, (b) an entity that generated the particular instance of map update data, or (c) a map element type to which the particular instance of map update data corresponds.

6. The method of claim 1, further comprising:
during the ingestion of at least one instance of map update data, identifying a contentious map update;
providing respective update confirmation requests to one or more probe devices corresponding to the contentious map update;
receiving respective update confirmations corresponding to the contentious map update; and
processing the respective update confirmations.

7. The method of claim 6, wherein the respective update confirmations are assigned respective instance rankings and assigned to respective data buckets based thereon.

8. An apparatus comprising at least one processor and at least one memory storing computer program instructions, the at least one memory and the computer program instructions are configured to, with the at least one processor, cause the apparatus to at least:
receive a plurality of instances of map update data during a time window, each instance of map update data of the plurality of instances of map update data associated with a respective geographic region of a plurality of defined geographic regions;
determine, for the time window, respective region rankings for the plurality of defined geographic regions, a region ranking for a particular geographic region determined based at least in part on one or more of (a) a number of the plurality of instances of map update data associated with a respective geographic region of the plurality of defined geographic regions, (b) a measure of map update activity corresponding to the respective geographic region, (c) a measure of inaccurate activity corresponding to the respective geographic region, (d) a weight assigned to the respective geographic region, or (e) an interest density corresponding to the respective geographic region,
determine, for the time window, respective ranking ranges for a plurality of data buckets;
assign a respective instance ranking to instances of map update data of the plurality of instances of map update data based at least in part on the respective geographic region associated with the respective instance of map update data and the respective region ranking determined for the respective geographic region;
assign instances of map update data to respective data buckets based on the respective instance rankings of the instances of map update data and the respective ranking ranges of the respective data buckets; and
ingest the respective instances of map update data based on the respective data buckets to cause a digital map maintained by the apparatus to be updated.

9. The apparatus of claim 8, wherein the respective instances of map data assigned to a particular data bucket are ingested using computational resources dedicated to the particular data bucket.

10. The apparatus of claim 8, wherein a first group of processing elements are configured to ingest respective instances of map data assigned to a first bucket of the plurality of data buckets and a second group of processing elements are configured to ingest respective instances of map data assigned to a second bucket of the plurality of buckets.

11. The apparatus of claim 8, wherein the region ranking for the particular geographic region is determined based at least in part on an error function.

12. The apparatus of claim 8, wherein the respective instance ranking for a particular instance of map update data is determined based at least in part on at least one of (a) a geographic area associated with the particular instance of update data, the geographic area being within the geographic region of the plurality of defined geographic regions associated with the particular instance of map update data, (b) an entity that generated the particular instance of map update data, or (c) a map element type to which the particular instance of map update data corresponds.

13. The apparatus of claim 8, wherein the at least one memory and the computer program instructions are further configured to, with the at least one processor, cause the apparatus to at least:
during the ingestion of at least one instance of map update data, identify a contentious map update;
provide respective update confirmation requests to one or more probe devices corresponding to the contentious map update;
receive respective update confirmations corresponding to the contentious map update; and
process the respective update confirmations.

14. The apparatus of claim 13, wherein the respective update confirmations are assigned respective instance rankings and assigned to respective data buckets based thereon.

15. A computer program product comprising at least one non-transitory computer-readable storage medium having computer-readable program code and/or instructions portions stored therein, the computer-readable program code and/or instructions portions comprising executable portions configured, when executed by a processor of an apparatus, to cause the apparatus to:
receive a plurality of instances of map update data during a time window, each instance of map update data of the plurality of instances of map update data associated with a respective geographic region of a plurality of defined geographic regions;
determine, for the time window, respective region rankings for the plurality of defined geographic regions, a region ranking for a particular geographic region determined based at least in part on one or more of (a) a number of the plurality of instances of map update data associated with a respective geographic region of the plurality of defined geographic regions, (b) a measure of map update activity corresponding to the respective geographic region, (c) a measure of inaccurate activity corresponding to the respective geographic region, (d) a weight assigned to the respective geographic region, or (e) an interest density corresponding to the respective geographic region,
determine, for the time window, respective ranking ranges for a plurality of data buckets;
assign a respective instance ranking to instances of map update data of the plurality of instances of map update data based at least in part on the respective geographic region associated with the respective instance of map update data and the respective region ranking determined for the respective geographic region;
assign instances of map update data to respective data buckets based on the respective instance rankings of the instances of map update data and the respective ranking ranges of the respective data buckets; and
ingest the respective instances of map update data based on the respective data buckets to cause a digital map maintained by the apparatus to be updated.

16. The computer program product of claim 15, wherein the respective instances of map data assigned to a particular data bucket are ingested using computational resources dedicated to the particular data bucket.

17. The computer program product of claim 15, wherein a first group of processing elements are configured to ingest respective instances of map data assigned to a first bucket of the plurality of data buckets and a second group of processing elements are configured to ingest respective instances of map data assigned to a second bucket of the plurality of buckets.

18. The computer program product of claim 15, wherein the region ranking for the particular geographic region is determined based at least in part on an error function.

19. The computer program product of claim 15, wherein the respective instance ranking for a particular instance of map update data is determined based at least in part on at least one of (a) a geographic area associated with the particular instance of update data, the geographic area being within the geographic region of the plurality of defined geographic regions associated with the particular instance of map update data, (b) an entity that generated the particular instance of map update data, or (c) a map element type to which the particular instance of map update data corresponds.

20. The computer program product of claim 15, wherein the computer-readable program code and/or instructions portions comprising executable portions are further configured, when executed by a processor of an apparatus, to cause the apparatus to:
during the ingestion of at least one instance of map update data, identify a contentious map update;
provide respective update confirmation requests to one or more probe devices corresponding to the contentious map update;
receive respective update confirmations corresponding to the contentious map update; and
process the respective update confirmations.
